(19) United States
(12) Patent Application Publication
(10) Pub. No.: US 2025/0312933 A1
(43) Pub. Date: Oct. 9, 2025

(54) Automatic Knife having Handle Inserts

(71) Applicant: Richard D. Hinderer, Shreve, OH (US)

(72) Inventor: Richard D. Hinderer, Shreve, OH (US)

(21) Appl. No.: 19/174,734

(22) Filed: Apr. 9, 2025

Related U.S. Application Data
(60) Provisional application No. 63/631,875, filed on Apr. 9, 2024.

(51) Int. Cl. B26B 1/04

(52) U.S. Cl. CPC B26B 1/044

(57) ABSTRACT

The assisted opening knife uses hardened handle inserts to reinforce the knife handles to prevent deformation and damage to the handles due to the blade impacting stop pins upon opening. The knife includes a blade pivotally connected between left and right handle members for rotational movement between open and closed positions. The handle inserts are mounted to the handle members and are seated within a recessed area formed on the interior face of the handle members. The handle inserts securely supporting the stop pins, which seat in holes formed in the handle inserts. Due to the hardened material, the handle inserts prevent deformation and damage to the softer handle members from impact of the blade against the stop pins.

This application claims the benefit of U.S. Provisional Patent Application, Serial No. 63/631,875 filed Apr. 9, 2024.

This invention relates to knives and in particular assisted opening knives having reinforcing handle inserts.

### BACKGROUND AND SUMMARY OF THE INVENTION

Assisted opening or automatic knives are well known to those in the art. Generally, assisted opening knives use a spring housed within the knife handle to exert a force on the blade to rotate the blade towards its open position. Stop pins carried within the handle engage contact surfaces on the blade to limit the movement of the blade at the open position. The impact force of the blade striking the stop pins often causes damage and deformation to the handle. This is true for knives using aluminum or polymer knife handles. While aluminum and polymer materials are light weight and non-corrosive, these handle materials are soft and malleable compared to ferrous and other metals. Consequently, stop pins mounted or supported directly in the knife handles constructed from such materials are subject to deformation and damage which lessens the function and life of the knife.

The assisted opening knife of this invention uses hardened handle inserts to reinforce the knife handles to prevent deformation and damage to the handles due to the blade impacting stop pins upon opening. The knife includes a blade pivotally connected between left and right handle members for rotational movement between open and closed positions. The assisted opening mechanism of the knife includes a pivot spring that exerts a force on the blade to move the blade toward the open position. Stop pins limit the travel of the blade at the open and closed positions. The handle inserts are mounted to the handle members and are seated within a recessed area formed on the interior face of the handle members. The handle members are constructed of a light weight polymer or metal, such as aluminum. The handle inserts are constructed of a hardened metal, such as steel or titanium. The handle inserts securely support the stop pins, which seat in holes formed in the inserts. Due to the hardened material, the handle inserts prevent deformation and damage to the softer handle members from impact of the blade against the stop pins, thereby improving performance and increasing the life of the knife.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes 6 of illustrating exemplary embodiments and are not to be construed as limiting the invention.

The drawings illustrate the present invention, in which:

FIG. 1 is a perspective view of an exemplary embodiment of the automatic knife of this invention;

FIG. 2 is a left side view of the knife of FIG. 1 having a portion cut away to show one of the handle inserts;

FIG. 3 is an exploded perspective view of the knife of FIG. 1;

FIG. 4 is a side view of the left side handle insert of the knife of FIG. 1;

FIG. 5 is a side view of the right side handle insert of the knife of FIG. 1;

FIG. 6 is a perspective view of the left side handle member and handle insert of the knife of FIG. 1;

FIG. 7 is a partial left side view of the knife of FIG. 1 having a portion cut away to show the blade in the open position; and

FIG. 8 is a partial left side view of the knife of FIG. 1 having a portion cut away to show the blade in the closed position.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced.

These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

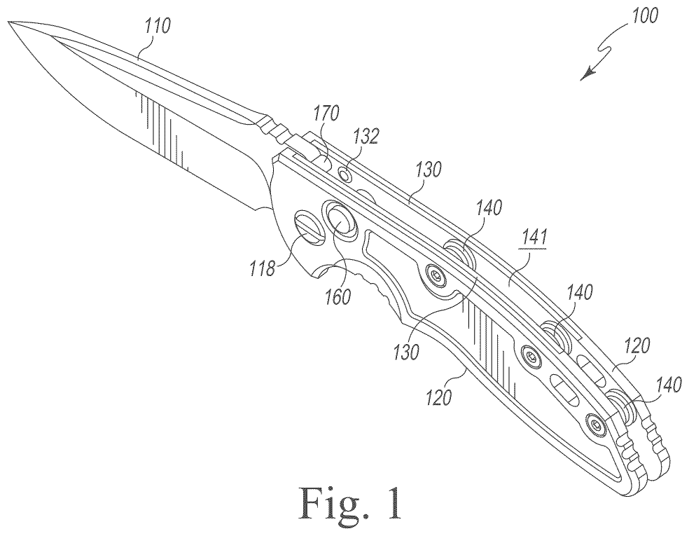

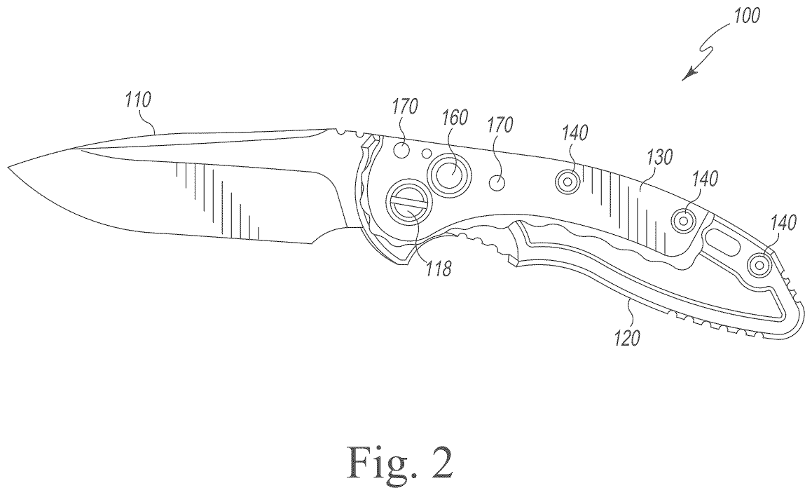

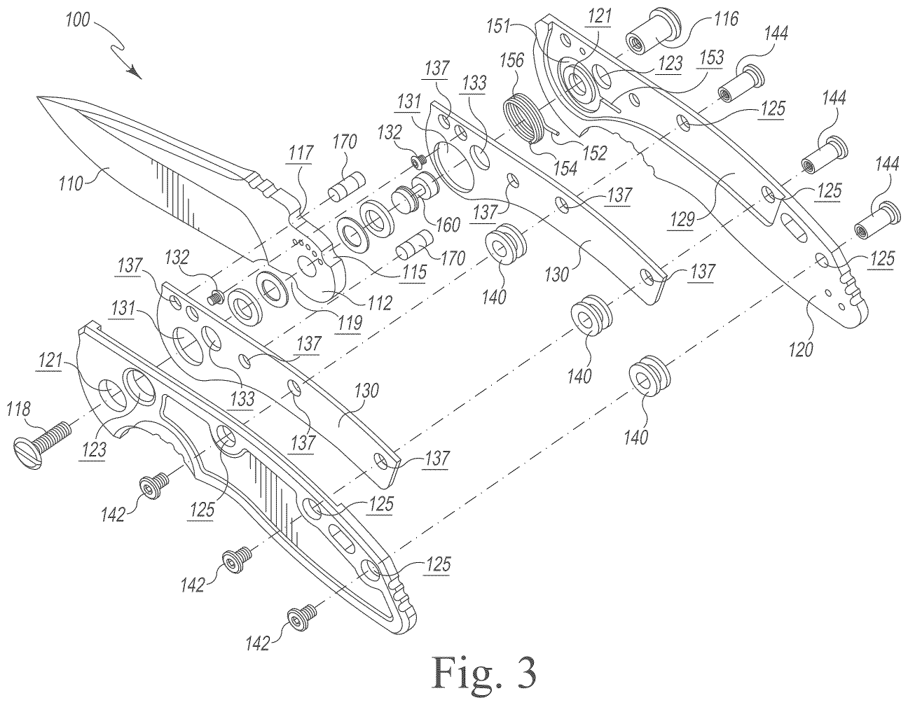

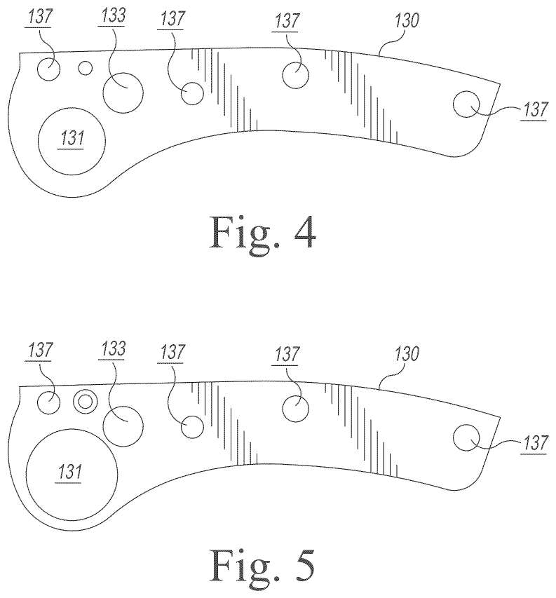

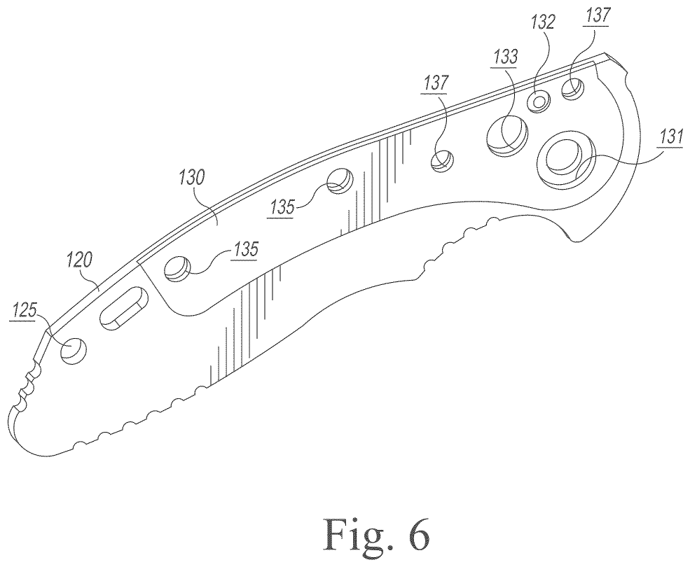

Referring now to the drawings, FIGS. 1-8 illustrate an exemplary embodiment of the automatic folding knife of this invention, which is designated generally as reference numeral 100. Knife 100 is an automatic or assisted opening knife that opens automatically with the press of a button. Knife 100 uses metal handle inserts to reinforce the knife handles to prevent deformation and damage to the handles due to the blade impacting stop pins upon opening. For ease of explanation, many commonly known features of automatic folding knives are omitted in the figures and description of embodiments of the invention. For example, fasteners, such as machine screws, bolts, rivets, pins, washers, etc. are well known in the art and need not be discussed in detail. Other features are described to provide context for the embodiment described, but are not essential to the invention or particular embodiment described and are not to be construed as being essential to the claimed embodiment unless so indicated.

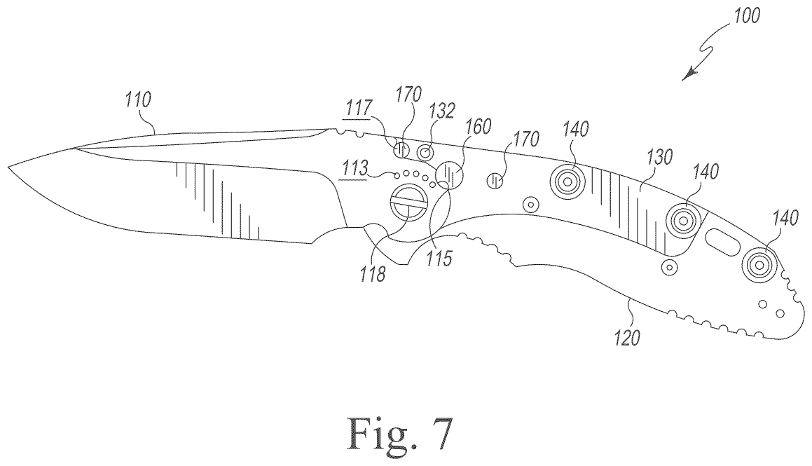

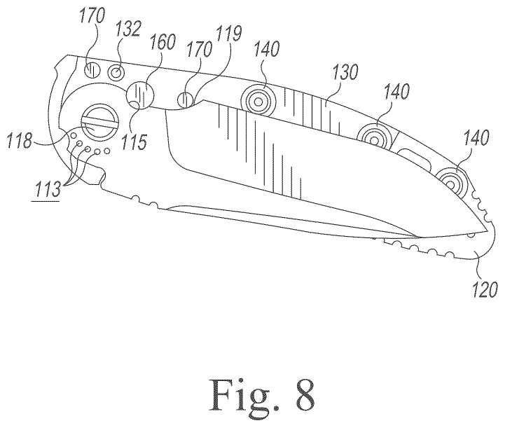

As shown, knife 100 includes a pivoting blade 110, a pair (right and left) of handle elements 120, reinforcing handle inserts 130, standoff 140, an assisted opening spring 150, blade opening button or plunger 160 and a pair of blade stops 170. Blade 110 pivotally coupled between left and right handle members 120 for rotational movement between an open position (FIGS. 1, 2 and 6) and a closed position (FIG. 8). Pivot spring 150 exerts force on blade 110 to move the blade toward the open position when plunger 160 is manually depressed. Stop pins 170 limit the travel of blade 110 at the open and closed positions. Handle inserts 130 prevent deformation and damage to the knife handles due to blade 110 impacting stop pins 170 (FIGS. 7 and 8).

Blade 110 is typically constructed from metals or other material suitable for use in cutting blades and may be ground in any desired blade configuration. Blade 110 has a tang 112 opposite the sharpened end. Tang 112 has a central pivot hole 111 and a series of holes 113 arranged in an arc around pivot hole 111. Blade tang 112 has a pair of plunger notches 115 and a pair of stop pin contact surfaces 117 and 119. Blade 110 is pivotally connected between left and right handle member 120 by a two piece pivot pin (consisting of a pivot barrel 116 and lock screw 118). Pivot barrel 116 extends through aligned holes in handle members 120 and pivot bore 111 and is secured by lock screw 118. 2

Handle members 120 (left and right sides) are generally planar plates cut, stamped or machined from metal sheets, such as aluminum or formed from a polymer material. Handle members 120 have aligned pivot holes 121 for receiving pivot barrel 118 and lock screw 119. The left side handle members have a plunger hole 123 for receiving plunger 160 and three standoff holes 125. Handle members 120 also have an interior recessed area 129 for receiving a reinforcing handle insert 130.

Reinforcing handle inserts 130 are generally cut or stamped from a suitably hardened metal, such as tool steel or titanium as a flat piece cut and shaped to seat within internal recessed area 139 of handle members 120. The metal from which handle inserts 140 are constructed is selected to be harder and more impact resistant than the material from which handle members 120 are constructed. Handle inserts 130 are seated within interior recessed area 123 of handle members 120 and secured by set screw 132. As shown, handle inserts 130 have a pivot hole 131, a plunger hole and standoff holes 135 complementary and aligned with respect to the corresponding holes in handle members 120.

Handle members 120 are spaced apart by standoffs 140 to form a space 141 for receiving blade 110 therein in the closed position. Standoffs 140 are cast, machined or otherwise formed from a suitable metal, such as steel, brass, copper, aluminum or titanium, but may be formed from a suitable composite ceramic or polymer material.

Standoffs 140 are affixed between handle members 120 by screws 142 that turn into barrel nuts 144, which extend through aligned holes 125 and 135 in handle members 120 and frame inserts 130.

Knife 100 uses an assisted opening mechanism, which includes generally a coil spring 150 and a manual button or plunger 160. Coil spring 150 sits over pivot barrel 118 and is operatively connected to blade 110 and the right side handle member 120. Coil spring 150 seats in an annular recess 151 formed in the right handle member 120 around pivot opening 121. Coil spring 150 has a first end tail 152 that is seated in a slot 153 formed in the interior face of right side handle member 120, and a second end tail 154 that extends into one of five bores 113. Coil spring 150 is wound to exert a rotational force on blade 110 to urge the blade toward the open position. Blade 110 locks in the closed position held by plunger 160 which seats within plunge notch 115 formed in blade 110.

Plunger 160 is shiftably supported between handle members 120. The end of plunger 160 extends partially from plunger opening 123 in left side handle member 120. Manually depressing plunger 160 dislodges plunger 160 from plunger notch 115 to release blade 110 from the closed position.

The movement of blade 110 between the open and closed position is limited by stop pins 170 and 172. Stop pins 170 and 172 are supported between handle members 120 and seated within aligned bores 137 in handle inserts 130. One stop pin 170 abuts directly against contact surface 117 in the open position and the other stop pin 170 abuts directly against contact surface 119 in the closed position. Handle inserts 130 reinforce stop pins and 172 to prevent damage and deformation of handle members 120 caused by the 13 impact of blade 110 impacting stop pins 170 seated within holes 137. 14

One skilled in the art will note several advantages of the handle inserts used in the automatic knife of this invention. The hardened handle inserts reinforce the handle members to prevent deformation and damage to the handles due to the blade impacting stop pins upon opening. The handle inserts securely support the stop pins, which seat in holes formed in the handle inserts. Because the handle inserts are constructed from a metal that is harder and more resilient than the material from which the handle members are constructed, the handle inserts prevent deformation and damage to the softer handle members from impact of the blade against the stop pins. Consequently, the handle inserts improve the performance and increase the life of the knife.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A folding knife having an assisted opening mechanism, comprising:
a pair of handle members;
a blade part pivotally mounted between the pair of handle members for movement between an open position where the blade extends from the handle members and a closed position where the blade is disposed between the handle members;
an assisted opening mechanism for urging the blade toward the open position;
a stop pin carried between the pair of handle members for engaging the blade to limit the movement of the blade at the open position, each of the handle members includes an insert for supporting the stop pin to prevent damage and deformation of the pair of handle members caused by the impact of the blade against the stop pin when the blade moves into the open position.

2. The knife of claim 1 wherein the pair of handle members is constructed of a handle material, the insert of each of the pair of handle members is constructed of an insert material, the hardness of the insert material is greater than the hardness of the handle material.

3. The knife of claim 1 wherein the pair of handle members are spaced apart from one another and have opposed facing interior surfaces, the insert of each of the pair of handle members overlies the opposed facing surface of each of the pair of handle members.

4. The knife of claim 3 wherein the opposed facing interior surface of each of the pair of handle members has a recessed area, the insert of each of the pair of handle members is seated within the recessed area of each of the pair of handle members.

5. The knife of claim 1 wherein the insert of each of the pair of handle members has a hole for securely receiving an end of the stop pin therein.
